(19) United States
(12) Patent Application Publication
(10) Pub. No.: US 2009/0078119 A1
(43) Pub. Date: Mar. 26, 2009

(54) Air Filter and System

(76) Inventor: Thomas Buckley, Lake Elsinore, CA (US)

Correspondence Address: BUCHANAN, INGERSOLL & ROONEY PC, POST OFFICE BOX 1404, ALEXANDRIA, VA, 22313-1404, US

(21) Appl. No.: 12/237,191

(22) Filed: Sep. 24, 2008

Related U.S. Application Data
(60) Provisional application No. 60/974,999, filed on Sep. 25, 2007.

(51) Int. Cl. B01D 46/42; B01D 39/14

(52) U.S. Cl. 96/222; 55/495

(57) ABSTRACT

A filter system including a frame with a central filtration portion is provided for delivery of volatile materials to the atmosphere to be filtered. Upon contact of a fluid to be filtered, a volatile or aromatic material is transferred to the incoming fluid so as to scent or condition the filtered fluid.

### CROSS-REFERENCE TO RELATED APPLICATION

This application claims priority to U.S. Patent Provisional Application No. 60/974,999, filed Sep. 25, 2007, which is incorporated herein by this reference in its entirety.

### FIELD OF THE INVENTION

This invention relates to an HVAC filter system and, more particularly, to a system which will deliver fragrances to air being forced through the system, the effective period of fragrance transfer corresponding to the life of the filter proper.

### BACKGROUND

Air quality, freshness and aroma provide health benefits in any number of ways (e.g., from removal of debris and dust, to the psychological aspects of aroma therapy).

### SUMMARY

The disclosure provides a filter unit comprising: a frame; an opening defined by the frame; and a filter material spanning the frame, the filter having inlet and outlet side relative to an air flow, wherein a portion of the filter material is impregnated or coated with a volatile material. In one aspect, the filter comprises a fibrous mesh. In another aspect, the fibrous mesh comprises at least a first and second fiber strand, wherein the first strand is impregnated or coated with a volatile material. The volatile material can comprise a scented material. In another aspect, the first strand comprises a coarse strand and the second strand comprises a fine strand.

The disclosure also provides a filter unit comprising: a frame; a porous tube or wick disposed on a surface of the frame; an opening defined by the frame; and a filter material spanning the frame. The filter unit can further comprise a reservoir in fluid communication with the porous tube or wick. The porous tube can comprise a plurality of pores (e.g., pores comprise pores of different size or the same size). In one aspect, the frame comprises a paper frame. In another aspect, the frame comprises cardboard, metal, or plastic.

The disclosure further comprises HVAC and vehicle cabin filter systems comprising a filter of the disclosure. The filter can be on the inlet or outlet side of such a system.

### DESCRIPTION OF DRAWINGS

FIG. 1 is a shows the flow of air through a filter or HVAC system.

FIG. 2A-C shows a filter unit of the disclosure.

### DETAILED DESCRIPTION

As used herein and in the appended claims, the singular forms “a,” “and,” and “the” include plural referents unless the context clearly dictates otherwise. Thus, for example, reference to “a filter” includes a plurality of such filters and reference to “the HVAC” includes reference to one or more HVACs known to those skilled in the art, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

Any publications discussed above and throughout the text are provided solely for their disclosure prior to the filing date of the present application. Nothing herein is to be construed as an admission that the inventors are not entitled to antedate such disclosure by virtue of prior disclosure.

Various apparatus and procedures have been proposed for the delivery of aromas into the conditioned air delivered by HVAC systems. The past systems do not appear to coordinate the life of aromatic delivery with the life of the furnace filter proper. In one aspect, a lack of fragrance can be indicative of a time to change the filter. In another aspect, the methods and compositions of the invention provides a reusable filter that allows for repeated addition of, or a change of, fragrance.

Using the filters and filter systems herein, a volatile material can be delivered into rooms, houses, hospitals, offices, theaters, buildings, vehicle cabins and the like.

A volatile material is a material that is vaporizable. As such, a volatile material can comprise an “aroma” and a “scent” including, but are not limited to pleasant or savory smells, but can also include vaporizable materials that also have antibacterial, antiviral, insecticidal, functions. For example, volatile materials include insecticides, air fresheners, deodorants, aromacology, aromatherapy, or any other odor that acts to condition, modify, or otherwise charge the atmosphere or to modify the environment.

A volatile material can comprise one or more active ingredients. Any suitable volatile material in any amount or form may be used. For example, a volatile material or composition useful in the filters and filter systems of the disclosure can comprise a single volatile material. One of skill will recognize that the volatile material or composition can comprise other materials in addition to the volatile substance that are not vaporizable but serve as a carrier, gelling agent and the like. The volatile materials described herein can be in any suitable form including, but not limited to: dispersion of solids, emulsions, liquids, and combinations thereof.

A fiber or frame comprises a surface. In one aspect, the surface can be an “evaporative surface”, which includes any suitable surface that allows for at least some evaporation of volatile materials. Any suitable evaporative surface device having any suitable size, shape, form, or configuration may be used. Suitable evaporative surface devices made from any suitable material, including but not limited to: natural materials, man-made materials, fibrous materials, non-fibrous materials, porous materials, non-porous materials, and combinations thereof.

The disclosure provides an aromatic distribution system comprising a frame comprising an aromatic gel or a frame comprising a microperforated tube and a reservoir comprising an aromatic. In another aspect, the disclosure provides a filter comprising a frame and a filter spanning the frame, wherein the filter is impregnated by an aromatic fragrance. In yet another aspect, the disclosure provides a mesh comprising an impregnated aromatic, wherein the mesh is designed to be fitted to a filter frame or filter. The aromatic fragrance can be disposed on either or both surfaces of a filter (e.g., the incoming air side, the outgoing air side, or both sides of a filter) or on a frame of a filter. As air moves across and through the filter components the aromatic fragrance is evaporated into the air and carried throughout the rooms or chamber connected to the HVAC system.

In one aspect, the life of the scent transfer corresponds with the useful life of the furnace filter so that the absence of scent in the conditioned air will indicate that the filter proper needs to be changed. The methods, systems and devices of the disclosure have application to any HVAC system (e.g., home and office). In addition, most vehicles (e.g., cars, trains, planes, and boats) have replaceable cabin filters for air filtration from both exterior air or interior circulated air. The filters of the disclosure have application and includes filters used in cabin filtration of vehicles.

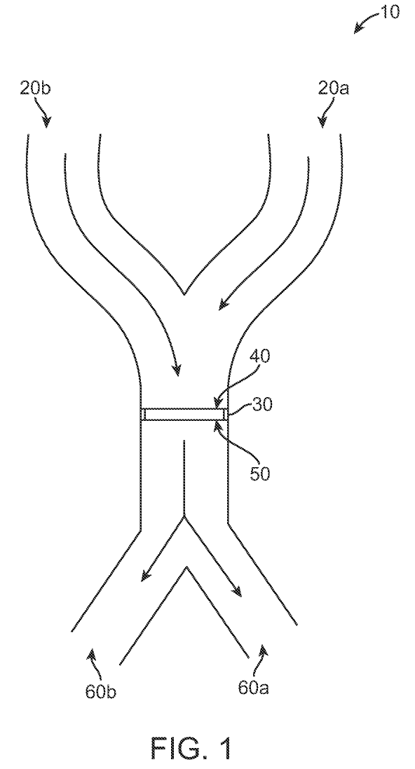

FIG. 1 is a general schematic of a filtration system. Such a system 10 comprises at least one inlet 20 (e.g., 20a and b and at least one outlet 60 (e.g., 60a and b). Disposed between and in fluid communication with the at least one inlet 20 and at least one outlet 60 is a filter 30 having an inlet side 40 and an outlet side 50. As air move from the inlet 20 to outlet 60, the air passes through filter 30. The pressure on the inlet side of filter 30 is higher than on the outlet side 50. The airflow and pressure can be controlled by fan or turbine in the system. The fan or turbine and be on the inlet side of the system to provide positive pressure or on the outlet side of the system to provide negative pressure to move air through the system 10.

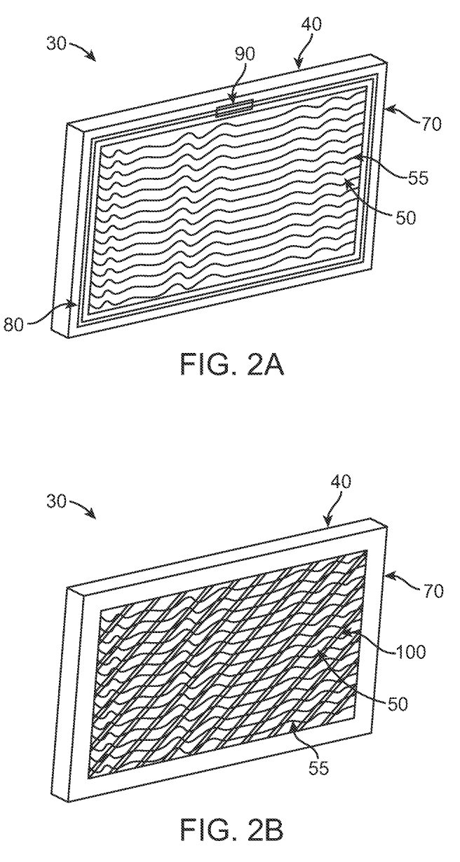

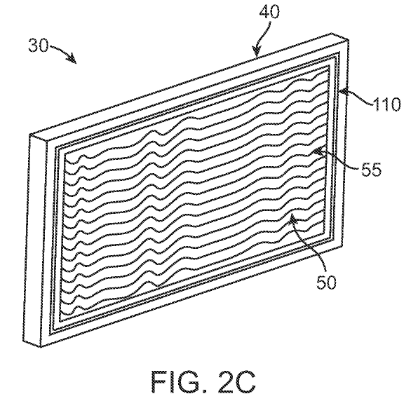

FIG. 2A-C show various embodiments of a filter useful in the disclosure. Depicted is a filter 30 having an inlet side 40 and an outlet side 50. A filter portion 55 comprising fibrous material (e.g., various polymers, glass, paper, and the like) is disposed within a frame 70. The frame 70 may be made of metal, cardboard, plastic or other materials known to those of skill in the art.

FIG. 2A shows an embodiment, wherein a perforated tube or wick 80 is disposed on the outlet side 50 of the frame 70. The perforated tube or wick 80 is fluidly connected to a reservoir 90 comprising an volatile fluid to be dispersed. In one aspect, the through-holes of the perforated tube 80 get larger the further distal to the reservoir 90, thereby promoting capillary action within the tube 80. Although the perforated tube or wick 80 is depicted as being in contact with the full perimeter of the frame 70, the perforated tube or wick 80 need not comprise the full perimeter, but may comprise a fraction or segment thereof sufficient enough to release a desired amount of volatile fluid into the atmosphere. The reservoir 90 can be replaced as need or refilled as needed. In one aspect, reservoir 90 can be a prefilled cartridge reservoir that can be replaced when the volume of fluid in the reservoir is empty or near empty.

A tube 80 comprising microporous openings (e.g., from about 0.1 μm to about 1 mm) is fluidly connected to the reservoir 90. When the reservoir 90 contains fluid, the fluid is transferred through the system by capillary action. As fluid evaporates through the microporous holes along a tube 80, the evaporation draws additional fluid from the reservoir by capillary action. The volume of air that crosses the tube will determine the rate of evaporation and thus the rate of refill and size of the reservoir. Various replacement reservoirs can be used comprising different fragrances. In this way, the fragrance in a system can be changed as desired.

FIG. 2B depicts a further aspect of the disclosure. In FIG. 2B the filter 55 comprises a mesh or fibrous material. During manufacture such mesh or fibrous materials are laid down such that they are intertwined and overlapping to generate a dense fibrous filter. Opposite sides (i.e., the inlet and outlet sides) of the fibrous filter may be supported by paper, cardboard or other material that extends across from one side of the frame to the other. In one aspect, each fiber of the fibrous material comprising the filter are of a homogenous thickness. In another aspect, the fibrous material comprise fibers of different thickness. In yet another aspect, the fibers of the fibrous material comprising the filter are layered such that fine fibers are interior to the mesh and course materials are external (i.e., facing outwardly). Such fibrous mesh is generated by extruding each fiber individually and combining the meshes either sequentially or simultaneously. As described herein, such fibers can be coated or impregnated with a volatile material. In one aspect, all the fibers are coated or impregnated with a volatile material. In yet another aspect, only a select number of fibers are coated or impregnated with a volatile material. In another aspect, only the course or the fine fibers are impregnated with a volatile material. As depicted in FIG. 2B, only a select number of fibers 100 comprising a volatile material are used in the filter. Where all members of the fibrous mesh are coated or impregnated a reduction in air flow may result due to a change in the overall diameter and the retention of particulate matter that is bound by the coating, thus reducing the life of the filter material. By coated or impregnating a select number of fibers (e.g., 1, 2, 3, 4, or 5), the life-expectancy of the filter can be increased while providing a volatile material into the air or atmosphere of the filter system.

In one aspect, multiple layers of fibrous or porous media can be used with at least two layers effectively comprising a coarse framework sandwiching fine fibers. In this aspect, the coarse framework or porous material comprises an impregnated volatile material. In general, stacked arrangements may be constructed from multiple layers of the same media composite. Alternatively, a measurable increase in density or fiber size can be provided in the stacked arrangement, for example, by using somewhat different composite materials or extrusion size fibers in each layer or applying layers appropriately while making a multi-layer composite. The materials in the various layers, for example, may be varied with respect to the average population density of the fine fibers across the open spaces of the coarse support. Alternatively, or in addition, the diameters of the fine fibers can be varied from layer to layer. Of course, arrangements can include one or more layers of one particular construction, and also one or more layers of a different construction or more than one different construction. In one aspect, the coarse fiber arrangement does not provide any measurable filtration relative to the composite of fine fibers. A principal function of the coarse material is the delivery of a volatile material to the atmosphere.

While the size of the fine fibers will be selected at least in part depending upon the particular use for which the construction is intended, the diameter of the coarse fibers is less important to filter operation and is selected based upon the volatile material being used. In general, the fiber diameters of the coarse fibers will be at least about 2 times, and typically and preferably about 6-200 times, the fiber diameters of the fine fibers. In general, the coarse fiber layer may comprise a collection or mix of short fibers or a non-woven substantially continuous fiber matrix.

A variety of filter materials can be used in the filters and filter systems of the disclosure. For example, glass fibers; polypropylene fibers; PVC fibers; and polyamide fibers can be used. More generally, polyacrylonitrile can be used and polyvinyladine chlorides can be used. Other suitable synthetic polymeric fibers can be used to make very fine fibers including polysulfone, sulfonated polysulfone, polyimid, polyvinylidine fluoride, polyvinyl chloride, chlorinated polyvinyl chloride, polycarbonate, nylon, aromatic nylons, cellulose esters, aerolate, polystyrene, polyvinyl butyryl, and copolymers of these various polymers.

The fine fibers can be secured to a volatile material-impregnated coarse support in a variety of manners. The technique used may depend, in part, on the process used for making the fine fibers or web, and the material(s) from which the fine fibers and coarse fibers are formed. For example, the fine fibers can be secured to the coarse support by an adhesive or they may be thermally fused to the coarse fibers. Coarse bicomponent fibers with a meltable sheath could be used to thermally bond the fine fibers to the coarse fibers. Alternatively, a coating comprising the volatile material may also provide a fusable material to bind the fibers to one another. Solvent bonding may be used, thermal binder fiber techniques may be applicable, and autogenous adhesion may be used. For adhesives, wet-laid water soluble or solvent based resin systems can be used. Urethane sprays, hot melt sprays, or hot melt sheets may be used in some systems. In some instances, it is foreseen that adhesives for positive securement of the fine fiber web to the coarse support, will not be needed. These will at least include systems in which, when the overall composition is made, the fine fiber is secured between layers of coarse material, and this positioning between the two coarse layers is used to secure the fine fiber layer or web in place.

Filter 30, thus can be made of a conventional air-permeable fibrous material so as to provide a conventional filtering function. The filter 30 can comprise scent-impregnated materials which contain a desired fragrance. It is understood that various methods of construction can be used for such filter. Strands of fibrous material used in the construction of a filter can be made by coating one or more strands of such material with a fragrance. For example, a coarse strand of a fibrous filter matrix can be extruded through a volatile material. In another aspect, a scented filter can be obtained by dipping the filter strands into the scented material, impregnating the scent into the materials during grid strand manufacture, utilizing scent-impregnated fibers in the strand material or other suitable construction.

FIG. 2C shows an embodiment wherein a volatile wax or gel 110 is disposed on the outlet side 50 of the frame 70. The volatile wax or gel 110 can comprise an amount of volatile material or an amount of wax that coincides with the life-expectancy of the filter itself. Although the volatile wax or gel 110 is depicted as being in contact with the full perimeter of the frame 70, the volatile wax or gel 110 need not comprise the full perimeter, but may comprise a fraction or segment thereof sufficient enough to release a desired amount of volatile fluid into the atmosphere.

Filters of the disclosure can also be developed that fit in individual room returns where filtered air returns from a air circulatory system. In such instances the filter material will be more course so as to reduce pressure in the system but of sufficient area to provide effective delivery of a volatile substance into the room's air. Such a filter can be of various sizes to accommodate standard and non-standard sizes. Typically the filter will be designed for self-installation by an occupant.

It is to be understood that while certain forms of this invention have been illustrated and described, it is not limited thereto except insofar as such limitations are included in the following claims and allowable functional equivalents thereof.

What is claimed is:

1. A filter unit comprising:
a frame;
an opening defined by the frame; and
a filter material spanning the frame, the filter having inlet and outlet side relative to an air flow, wherein a portion of the filter material is impregnated or coated with a volatile material.

2. The filter unit of claim 1, wherein the filter material comprises a fibrous mesh.

3. The filter unit of claim 2, wherein the fibrous mesh comprises at least a first and second fiber strand, wherein the first strand is impregnated or coated with a volatile material.

4. The filter unit of claim 1, wherein the volatile material comprises a scented material.

5. The filter unit of claim 3, wherein the first strand comprises a coarse strand and the second strand comprises a fine strand.

6. A filter unit comprising:
a frame;
a porous tube or wick disposed on a surface of the frame;
an opening defined by the frame; and
a filter material spanning the frame.

7. The filter unit of claim 6, further comprising a reservoir in fluid communication with the porous tube or wick.

8. The filter unit of claim 6, wherein the porous tube comprises a plurality of pores.

9. The filter unit of claim 8, wherein the plurality of pores comprise pores of different size.

10. The filter unit of claim 6, wherein the frame comprises a paper frame.

11. The filter unit of claim 6, wherein the frame comprises cardboard, metal, or plastic.

12. The filter unit of claim 7, wherein the reservoir comprises a volatile material.
